(19) United States
(12) Patent Application Publication
(10) Pub. No.: US 2008/0013771 A1
(43) Pub. Date: Jan. 17, 2008

(54) Safe Earphone

(76) Inventor: Aidao Zhu, Wenzhou (CN)

Correspondence Address: GLOBAL IP SERVICES, 7285 W. Eagle Court, Winton, CA, 95388, US

(21) Appl. No.: 11/458,090

(22) Filed: Jul. 17, 2006

(51) Int. Cl. H04R 25/00

(52) U.S. Cl. 381/374; 381/380

(57) ABSTRACT

This invention involves a safe earphone, applied to the communication equipment like mobile phones with severe radiations of high frequency magnetic field, comprising an ear-insert, a sound transmitting passage for transmitting sound wave, a micro-speaker, a microphone, a lead, a plug and a shell. The ear-insert is connected with the micro-speaker by the sound transmitting passage. The technical design for this invention is to remove the micro-speaker out from the ear-insert, and put it far away human's ears. Using the sound transmitting passage for transmitting sound wave to users' ear. Thus, the safe earphone will be able to minimize the magnetic field strength from micro-speakers or mobile phone, so as to prevent harmful magnetic field to damage users' brains, and to avoid long time users suffering from such diseases as headaches, dizzies, and numbness. Further more, the sound heard from the safe earphone is clearer the common earphone.

### FIELD OF THE INVENTION

This invention is a kind of earphone, especially is a kind safe earphone without magnetic field and radiation harm to users. It belongs to electronic audio equipment.

### BACKGROUND OF THE INVENTION

A common earphone usually comprises a plug, a lead, and an ear-insert with an in-built micro-speaker. People know the mobile phone produces harmful radiations of high frequency magnetic field, it stimulates user's brain nerve so much that brings serious negatively influence to user. Therefore, many people use earphone plus mobile phone for communication to reduce harms to user caused by the magnetic field, as well as radiations like electric wave and thermal energy. However, Using a common earphone for a mobile phone still cannot block the radiations of high frequency magnetic field reaching user's ear, avoid the harm to their brains. Furthermore, the magnetic field with low frequency produced by the earphone itself will also bring the harm to users' brains. Thereby, using a mobile phone or earphone for a long time will make users suffering from such diseases as headaches, dizzies, and numbness.

### SUMMERY OF THE INVENTION

The purpose of the present invention is to provide a kind of safe earphone, which can block the radiation of high frequency magnetic field produced by the mobile phone and the magnetic field with low frequency produced by the earphone itself, therefore, to eliminate the negative impact on human body when people use the mobile phone or earphone.

The conceive of the present invention is that a safe earphone comprises an ear-insert, a micro-speaker, a plug and a lead, the micro-speaker is located far away from user's ear, a sound transmitting passage connects the ear-insert and the micro-speaker for transmitting sound wave and shielding magnetic field.

With a view to the conceive, the micro-speaker is moved away from the ear-insert, letting sound wave from micro-speakers go through a sound transmitting passage with a certain length before reaching users' ears. Therefore, the sound transmitting passage blocks the radiation of high frequency magnetic field and the magnetic field with low frequency. In other way, the micro-speaker is moved far away from users' ear, weakens the impact of magnetic field from the micro-speaker.

The sound transmitting passage can be either made of a segment of hose or tube, the ear insert and the micro-speaker are connected by the hose or tube. Furthermore, the micro-speaker, the ear-insert and the sound transmitting passage can be designed as an integration unit. The latter option looks more beautiful.

Since the micro-speaker in this invention is removed from the ear-insert, keeping a certain distance from user's ears, the magnetism field from the micro-speaker can be minimized, thus, the harm done on human bodies, brains in particular by the high frequency radiations can be minimized.

### BRIEF DESCRIPTION OF THE DRAWINGS

FIG. 1A is a cross-sectional view of the first embodiment of this invention;

FIG. 1B is a front view of the first embodiment shown in FIG. 1A.

FIG. 1C is a right side view of the first embodiment shown in FIG. 1A.

FIG. 2A is a cross-sectional view of the second embodiment of this invention;

FIG. 2B is a front view of the second embodiment shown in FIG. 2A.

FIG. 2c is a right side view of the second embodiment shown in FIG. 2A.

FIG. 3A is a cross sectional view of the third embodiment of this invention;

FIG. 3B is a front view of the third embodiment shown in FIG. 3A.

FIG. 3C is a right side view of the third embodiment shown in FIG. 3A.

FIG. 4A is a sketch drawing of the forth embodiment of this invention;

FIG. 4B is a sketch drawing of fifth embodiment of this invention of this invention.

FIG. 4C is a sketch drawing showing the number of the micro-speaker used for the forth or fifth embodiment can be one.

### DETAILED DESCRIPTION OF THE INVENTION

Although the following detailed description contains many specifics for the purposed of illustration, any one of ordinary skill in the art will appreciate that many variations and alterations to the following details are within the scope of the invention. Accordingly, the following preferred embodiment of the invention is set forth without any loss of generality to, and without imposing limitations upon, the claimed invention.

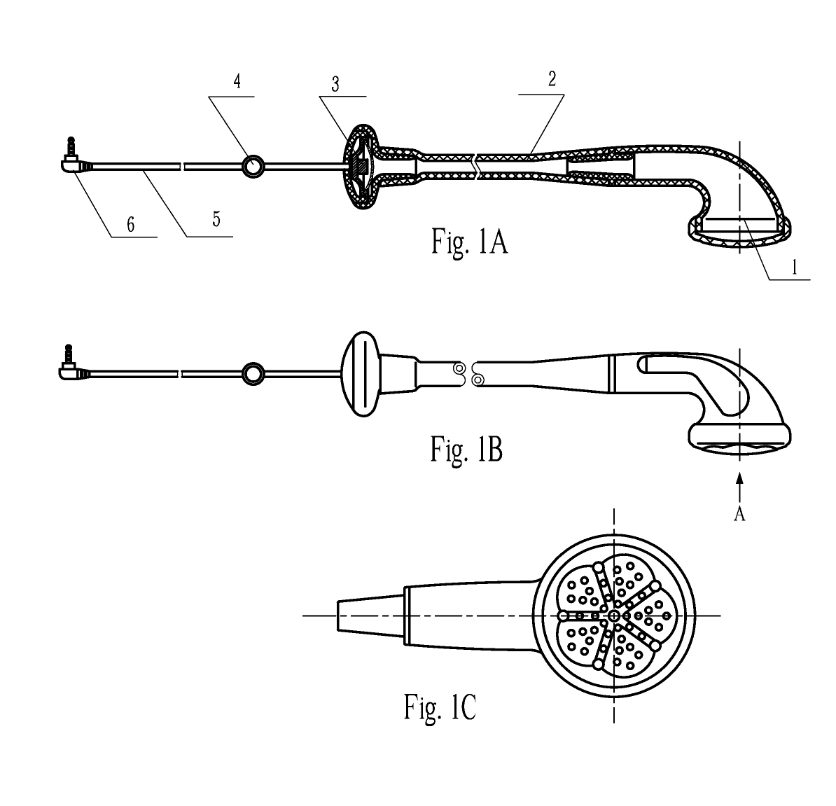

As shown in FIGS. 1A, 1B and 1C, the first embodiment of the safe earphone comprises a plug (6), a lead (5), a micro-speaker (3), an ear-insert (1), and a sound transmitting passage (2), which is a hose or tube. One end of the passage is connected to the ear-insert for sound wave output, and the other end to the micro-speaker for sound wave input. In this embodiment, a microphone (4) is connected in the middle of the lead (5) linking the micro-speaker (3) for picking up users' voice. Electric signals will, in turn, goes through the plug (6), the lead (5), the microphone (4), and to the micro-speaker (3) to be turned into sound wave, which will goes through the sound transmitting passage (2) and the ear-insert (1) then reaching users' ear. After sound wave goes the passage (2) and the ear-insert (1), the magnetic field sign will eliminated. Both the length and the inner diameter of the sound transmitting passage (2) made of a segment of hose or tube depends on the sound wave intensity and the magnetic field strength from the micro-speaker, as well as the size of a earphone. This safe earphone can protect user's brain from harm by magnetic field, and can make sound from the micro-speaker clearer.

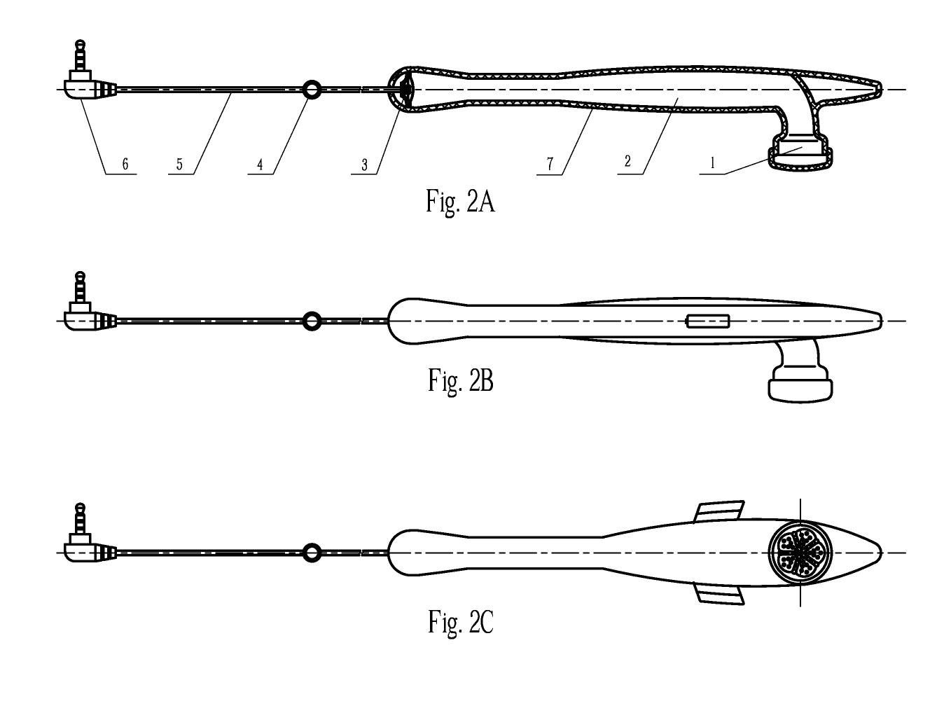

As shown in FIG. 2A, 2B, 2C, the second embodiment of this invention is an earphone. It comprises a micro-speaker (3), a sound transmitting passage (2), an ear-insert (1), and a shell (7). The micro-speaker (3) is located at one end of the shell (7), the ear-insert (1) at the other end, and the sound transmitting passage (2) in the middle. The micro-speaker (3), microphone (4), and the plug (6) are connected in turn through the lead (5).

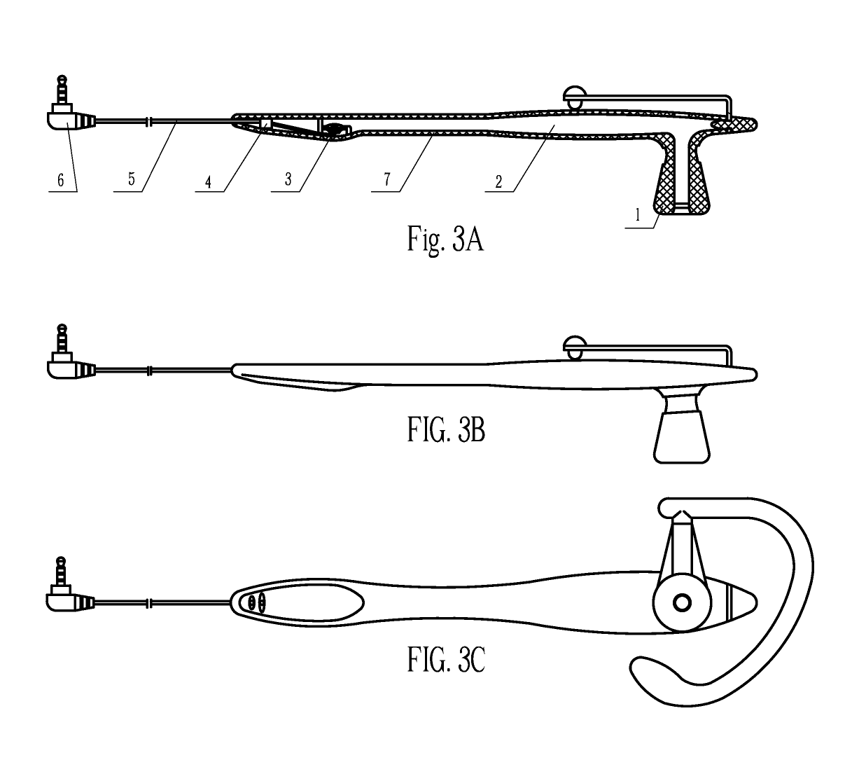

As shown in FIG. 3A, 3B, 3C, the third embodiment of this invention is an earplug. It comprises a micro-speaker (3), a sound transmitting passage (2), an ear-insert (1), a microphone (4), and a shell (7). The micro-speaker (3) is located at one end of the sell (7), and the ear-insert at the other end. Between the micro-speaker (3) and the ear-insert (1) located the sound transmitting passage (2). And the micro-speaker (3), the microphone (4), and the plug are connected in turn by the lead (5).

As shown in FIGS. 3A and 3B, the ear-insert (1) has a front end with a larger arc, and the diameter of the front end is bigger than the same of the bottom end. This ear-insert is not only fits itself well into users' ear but also makes users feel very comfortable with it.

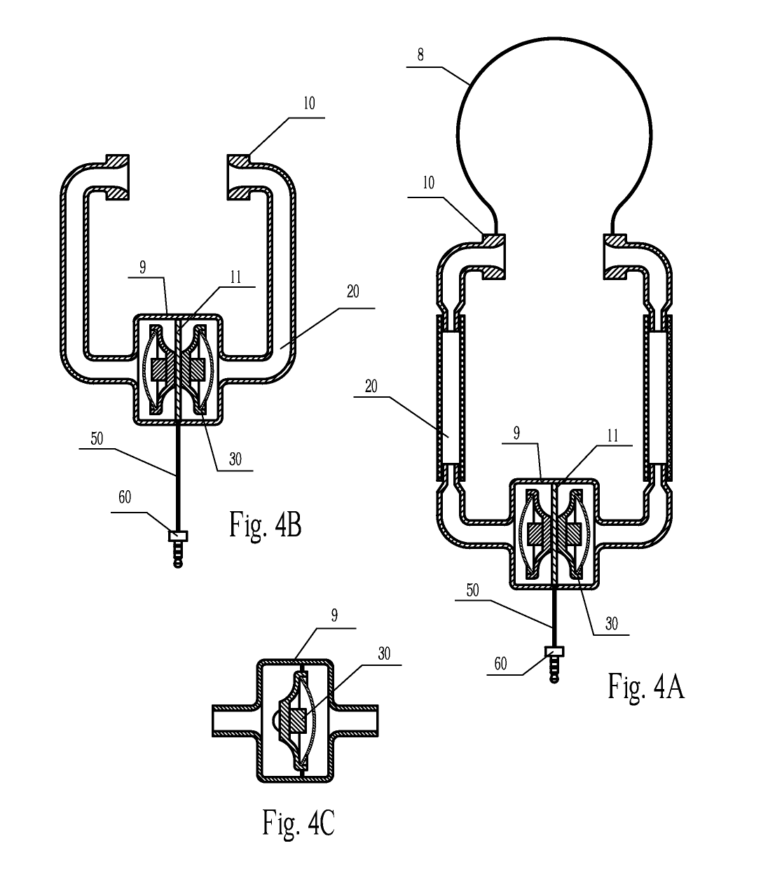

As shown in FIG. 4A, the forth embodiment of this invention is a headphone. It comprises two hearing heads (10); two micro-speakers (30) in a chamber (9) are separated by a sound insulation board (11); the two hearing heads (10) are connected with the two micro-speakers (30) by the sound transmitting passages (20), such as a hose or tube; a plug (60) is connected with the two micro-speakers (30) by a lead (50); elastic bar (8) connects the two hearing head (10) for holding the head phone on user's head. The sound issued by the micro-speaker (30) through the sound transmitting passage (20) to the hearing heads (10) then to user's ears. User can use this head phone (10) to listen stereo sound.

As shown in FIG. 4B, the fifth embodiment of this invention is a headphone. The fifth embodiment is similar with the forth embodiment. The differences are that omit the elastic bar (8), the sound transmitting passage and other parts of the headphone are made as a whole unit. The sound transmitting passage is an elastic pipe. This headphone is clipped on the user's ears from user's chin.

As shown in FIG. 4C, the number headphone shown on the FIG. 4A or 4B can be one micro-speaker (30) only.

What is claimed is:

1. A safe earphone comprising a plug, a lead, a micro-speaker, and an ear-insert; the micro-speaker being located far away from user's ear; a sound transmitting passage connecting the ear-insert and the micro-speaker for transmitting sound wave and shielding magnetic field.

2. The safe earphone of claim 1, wherein the sound transmitting passage is made of a hose or tube.

3. The safe earphone of claim 1, wherein the micro-speaker, sound transmitting passage, ear-insert are included in a shell, the micro-speaker is located at one end of the shell, the ear-insert at the other end of the shell, the sound transmitting passage connects the ear-insert and micro-speaker together.

4. The safe earphone of claim 1, wherein a microphone is connected with the micro-speaker.

5. The safe earphone of claim 1, wherein The shell is shaped long and thin, the ear-insert is fixed on one end of the shell, the micro-speaker is fixed other end far away the ear-insert, the shell becomes the sound transmitting passage.

6. The safe earphone of claim 1, wherein the ear-inserts are two hearing heads, two micro-speakers in a chamber are separated by a sound insulation board, the two hearing heads are connected with the two micro-speakers by two sound transmitting passages.

7. The safe earphone of claim 6, wherein the hearing heads, the micro-speakers and the sound transmitting passage are combined as a whole unite, the transmitting passage is an elastic pipe.

8. The safe earphone of claim 6, wherein the number of micro-speaker is one.

9. The safe earphone of claim 7, wherein the number of micro-speaker is one.
